(19) United States
(12) Patent Application Publication
(10) Pub. No.: US 2008/0200854 A1
(43) Pub. Date: Aug. 21, 2008

(54) METHOD OF TREATING MUSCLE SORENESS OR A SOFT TISSUE OEDEMA

(75) Inventors: Barry Reginald Hobson, North Lake (AU); Angelo Paoliello, Sawyer Valley (AU)

Correspondence Address: MCGARRY BAIR PC, 32 Market Ave. SW, SUITE 500, GRAND RAPIDS, MI, 49503, US

(73) Assignee: MERLEX CORPORATION PTY LTD, Bentley (AU)

(21) Appl. No.: 12/042,840

(22) Filed: Mar. 5, 2008

(30) Foreign Application Priority Data
Dec. 6, 2006 (AU) PCT/AU2006/001856

(51) Int. Cl. A61H 7/00; A61H 15/00

(52) U.S. Cl. 601/136; 601/134; 601/112

(57) ABSTRACT

The present disclosure provides in a method of treating muscle soreness or soft tissue oedema. The method comprises frictionally engaging a contact member of an apparatus with skin portions of a patient. The contact member of the apparatus is arranged to perform a substantially planar orbital motion along the skin portions. The method further comprises applying the substantially planar orbital motion along the skin portions of the patient so that soft tissue adjacent the skin portion is locally moved in a corresponding manner. The movement typically is a non-circular orbital movement having a base frequency and harmonics. The movement of the soft tissue results in a distortion of portions of lymph nodes located within the soft tissue whereby throughput of lymphatic fluid through lymph nodes is enhanced.

### FIELD OF THE INVENTION

The present invention broadly relates to method of treating muscle soreness or a soft tissue oedema.

### BACKGROUND OF THE INVENTION

It has been previously reported that muscle damage is induced by unaccustomed or strenuous exercise, for example when lengthening muscles or during eccentric contractions and in particular when muscle lengthening and force generation occur simultaneously. Symptoms of muscle damage include delayed onset of muscle soreness (DOMS), which is characterized by stiffness, pain, reduced range of motion, prolonged impairment of muscle function and swelling. The symptoms of DOMS may persist for several days or even weeks after the exercise. The symptoms affect daily activities through loss of mobility and athletic performance.

In some professional circles it is thought that an inflammatory process in muscle repair is the underlying cause of DOMS, but as yet this has been unproven. Difficulty arises in identifying the cause of DOMS due to the complex cascading events that take place during muscle injury. Previous studies have attempted to qualify the inflammation hypothesis through the intervention and use of non steroidal anti-inflammatory drugs, but the results of these studies are inconclusive. Other researches believe that the pain associated with DOMS is related to the group III and IV afferent nerve fibres within the skeletal muscle and which are activated during damage to muscle fibre.

Many interventions have been tested in the past, but none have offered an effective magnitude of relief that enables a reduction in associated pain symptoms. Attempts have been made to reduce the effects of DOMS using cryotherapy, stretching, whirlpool therapy, anti-inflammatory drugs, ultrasound, electrical current techniques (TENS), homeopathy, massage, compression, hyperbaric oxygen therapy, and exercise. Unfortunately only limited success has been reported to date. There is a need for technological advancement.

### SUMMARY OF THE INVENTION

The present invention provides in a first aspect a method of treating muscle soreness, the method comprising the steps of:

frictionally engaging a contact member of an apparatus with skin portions of the patient who experiences the muscle soreness, the contact member of apparatus being arranged to perform a substantially planar orbital motion along the surface of the skin portions; and

applying the substantially planar orbital motion along the skin portions of the patient so that soft tissue adjacent the skin portions is locally moved in a corresponding manner, the skin portions including first and second skin portions, the soft tissue adjacent the first skin portion including first lymph nodes and being remote from the soft tissue region in which the patient experiences the muscle soreness, the soft tissue adjacent the second skin portion including second lymph nodes and at least a portion of the soft tissue region in which the patient experiences the muscle soreness;

whereby the movement of the soft tissue results in a distortion of portions of the first and second lymph nodes whereby throughput of lymphatic fluid through the first and second lymph nodes is enhanced.

The inventor has observed that the application of the substantially planar orbital motion to at least one skin portion of the patient, which results in the increased throughput of lymphatic fluid through lymph vessels and lymph nodes, reduces muscle soreness and/or reduces a time during which a patient may experience muscle soreness.

Throughout this specification the meaning of the term “soft tissue” includes for example epidermis, dermis, subcutaneous tissue (i.e. epifascial tissue), skeletal and smooth muscle tissue.

Throughout this specification the term “orbital motion” is used for a non-rotational, at least two dimensional motion along a closed loop pathway.

The method typically is conducted so that the contact member is initially engaged with the first skin portion and subsequently with the second skin portion and the substantially planar orbital motion is initially applied to the first skin portion and subsequently to the second skin portion.

The substantially planar orbital motion typically is a non-circular motion having a fundamental frequency and one or more associated harmonics.

The present invention provides in a second aspect a method of treating muscle soreness, the method comprising the steps of:

frictionally engaging a contact member of an apparatus with a skin portion of a patient who experiences the muscle soreness, the contact member of the apparatus being arranged to perform a substantially planar non-circular orbital motion along the surface of the skin portion, the motion having a fundamental frequency and one or more associated harmonics; and

applying the substantially planar non-circular orbital motion along the skin portion of the patient so that soft tissue adjacent the skin portion is locally moved in a corresponding manner and at least portions of the lymph system positioned in the soft tissue are distorted by that motion;

whereby throughput of lymphatic fluid through that portion of the lymph system is enhanced.

The method in accordance with the second aspect of the present invention typically comprises applying the substantially planar non-circular orbital motion along first and second skin portions of the patient so that soft tissue adjacent the first and second skin portions is locally moved in a corresponding manner, the soft tissue adjacent the first skin portion including first lymph nodes and being remote from the region in which the patient experiences the muscle soreness, the soft tissue adjacent the second skin portion including second lymph nodes and at least a portion of the region in which the patient experiences the muscle soreness.

The following description relates to features that the method in accordance with the first or the second aspect of the present invention may comprise.

In one specific embodiment of the present invention the method is conducted to treat delayed onset muscle soreness (DOMS), which typically is experienced as pain and stiffness following athletic performance, unaccustomed exercise or strenuous non-athletic activity. For example, the muscle soreness may be a consequence of physical exercise or work related muscular movement. Such muscle soreness may affect the wellbeing of a person during a period of a few days or even a week after the exercise.

The method typically comprises applying the substantially planar orbital motion to a plurality of first and second skin portions. In one specific embodiment the method comprises applying the substantially planar orbital motion initially to one of the first skin portions and subsequently to one of the second skin portions. The method typically is conducted so that the substantially planar orbital motion is initially applied to all first skin portions and subsequently to all second skin portions.

The method typically comprises moving the apparatus with the contact member so that substantially planar orbital motion is applied at a plurality of positions along a path from an initial proximal location that is remote from the soft tissue region in which the patient experiences the muscle soreness to a position at the soft tissue region in which the patient experiences the muscle soreness.

For example, if the patient experiences muscle soreness at a limb, such as an arm, the substantially planar orbital motion may initially be applied to skin portions at the torso of the patient, typically to an area in the proximity of lymph nodes such as in the pectoral muscle region and or arm pit region, before the substantially planar orbital motion is applied to skin portions at the limb. Alternatively, if the patient experiences muscle soreness at a leg, the substantially planar orbital motion may initially also be applied to skin portions at the torso of the patient, typically to an area in the proximity of lymph nodes in the groin/abdomen region on the associated side of the sore limb before the substantially planar orbital motion is applied to skin portions at the leg.

The above-defined method typically is conducted to provide also analgesic pain relief. Further, muscle soreness is also often associated with a reduced range of motion (ROM) and the method typically is conducted to increase the ROM.

The present invention provides in a third aspect a method of treating a soft tissue oedema, the method comprising the steps of:

frictionally engaging a contact member of an apparatus with a skin portion of a patient who experiences the soft tissue oedema, the contact member of the apparatus being arranged to perform a substantially planar non-circular orbital motion along the surface of the skin portion, the motion having a fundamental frequency and one or more associated harmonics; and

applying the substantially planar non-circular orbital motion to at least one skin portion of the patient so that soft tissue adjacent the skin portion is locally moved in a corresponding manner whereby the substantially planar non-circular orbital motion causes distortions of at least a portion of the lymph system whereby throughput of lymphatic fluid through the portion of the lymph system is increased.

The soft tissue oedema typically relates to lymphedema.

The method in accordance with the third aspect of the present invention typically comprises moving the apparatus to further skin portions of the patient and at each further skin position frictionally engaging the contact member of the apparatus with the respective further skin portion; and

applying the substantially planar non-circular orbital motion to each further skin portion of the patient so that soft tissue adjacent each further skin portion is locally moved in a corresponding manner.

The following description relates to features that the method in accordance with the first second or third aspect of the present invention may comprise.

The method may comprise applying the substantially planar orbital motion or substantially non-circular orbital motion to more than 5 or more than 10 skin portions of the patient.

The method typically is conducted so that the movement of the soft tissue is at least locally a largely two dimensional planar movement in the plane of the skin, but may also extend along curvatures of the surface of the patient.

The method typically is conducted so that the substantially planar non-circular orbital motion has a fundamental frequency or pattern rate in the range of 20 to 1 kHz, 30 to 800 Hz, 40-500 Hz, 50-200 Hz, or 50-100 Hz. The amplitude of the substantially planar non-circular orbital motion typically is of the order of 0.1-5 mm, 0.2-2 mm, 0.3-1.0 mm, or 0.5-0.8 mm peak to peak.

The inventor has also observed that the extension of the movement of the soft tissue along the surface of the human body is dependent on the fundamental frequency of the substantially planar non-circular orbital motion that is applied by the contact member. For example, if the fundamental frequency of the applied motion corresponds to a resonance frequency of the soft tissue of the patient, the extension of the tissue motion is particularly large. The extension of the movement is also dependent on the individual physiology of the soft tissue of each patient. For example, some patients may have a large amount of adipose fat cells, fibrotic tissue or scar tissue, where as other may have a fluidy oedema.

The method may also comprise the step of selecting an increase or decrease in amplitude displacement of the contact member. Further, the method may comprise selecting extension of the movement of the soft tissue along the surface of the patient by selecting the frequency of the planar non-circular orbital motion that is applied by the contact member.

The substantially planar non-circular orbital motion typically is associated with a hypotrochoidal or epitrochoidal pathway of motion of the contact member.

Because the substantially planar non-circular orbital motion typically is a complex motion having a fundamental frequency and a range of associated harmonics, the method typically also comprises applying a harmonic frequency motion component to the skin portions. The frequencies of the harmonics may be in the proximity of resonance frequencies of small portions of the soft tissue structure or of inflammatory cells such as neutrophils, macrophages, lymphocytes and free radicals, etc. of the patient.

The present invention provides in a fourth aspect an apparatus for treating muscle soreness, the apparatus being arranged for operation in accordance with the method of the first or second aspect of the present invention.

The present invention provides in a fifth aspect an apparatus for reducing lymphedema, the apparatus being arranged for operation in accordance with the method of the third aspect of the present invention.

The apparatus according to the fourth or fifth aspect of the present invention typically is portable and may be hand-held.

The present invention provides in a sixth aspect a hand held tool comprising:

a handle;

a contact member having a contact surface portion lying in a first plane;

an electric motor having a stator and an armature, the armature being moveable with a non-rotary translational motion of the armature in a second plane relative to the stator, wherein the handle is attached to one of the stator and the armature and the contact member is attached to another of the stator, and wherein the armature with the handle and the contact surface are maintained at substantially constant spacing from each other while the armature is in motion, and wherein the first plane is parallel to the second plane, whereby the relative motion between the armature and the stator produces a corresponding motion of the contact member relative to the handle.

The invention will be more fully understood from the following description of specific embodiments of the invention. The description is provided with reference to the accompanying drawings.

### BRIEF DESCRIPTION OF THE DRAWINGS

FIG. 1 shows examples of patterns that correspond to motions applied to skin portions in accordance with embodiments of the present invention;

FIG. 2 shows a perspective view of an apparatus for generating an orbital motion in accordance with an embodiment of the present invention;

FIG. 3 shows a section view of the apparatus shown in FIG. 2;

FIG. 4 shows a partial exposed view of the apparatus in FIGS. 2-3;

FIG. 5 is an exploded view of a motor incorporated in the apparatus shown in FIGS. 2-4;

FIG. 6 shows a flow chart of a method of treating muscle soreness according to an embodiment of the present invention;

FIG. 7 illustrates skin areas of a patient at which a contact member of an apparatus for performing a substantially planar non-circular orbital motion is applied in accordance with an embodiment of the present invention;

FIGS. 8 to 11 show plots of muscle soreness experienced by subjects as a function of time; and

FIGS. 12 and 13 illustrate peak muscle soreness as experiences by subjects.

### DETAILED DESCRIPTION OF SPECIFIC EMBODIMENTS

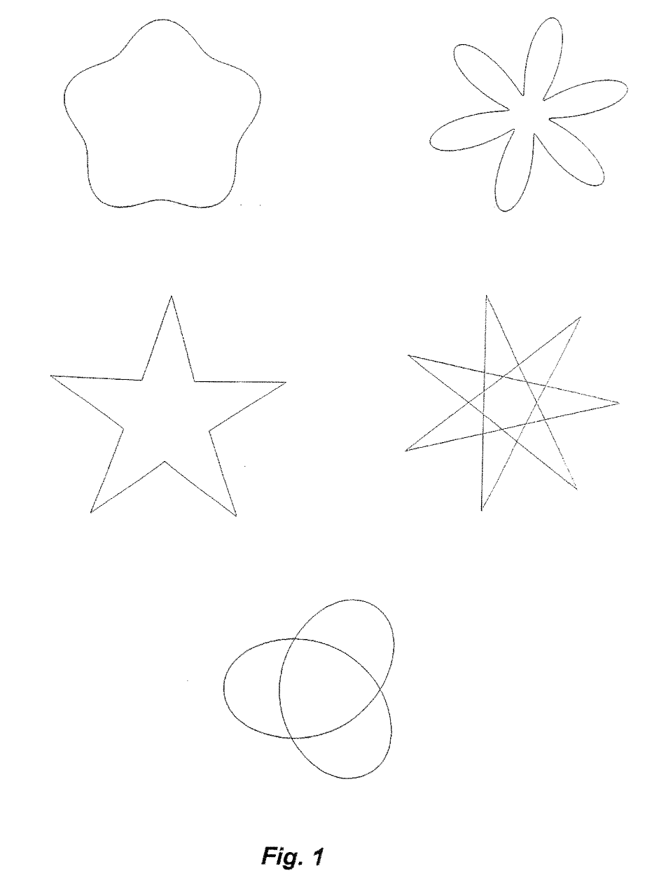

Embodiments of the present invention provide a method of treating muscle soreness. The method comprises applying a substantially planar orbital motion to the plane of skin portions of a patient using an apparatus that generates such a motion. The motion may be a circular motion, but typically is a non-circular orbital motion that has a fundamental frequency and a range of associated harmonics. FIG. 1 shows five examples of closed loop paths defining such motions that are applied to skin portions of a patient in accordance with embodiments of the present invention. The motions locally move soft tissue adjacent the skin portions in a corresponding motion whereby throughput of lymphatic fluid through the lymph system is increased.

The lymph system comprises lymph nodes and lymph vessels and provides one of the major pathways for the departure of specialised mononuclear cells and waste products from the body's tissue spaces. The ease with which they enter and move along the lymph system is a crucial part of the body's response to infection and inflammation, such as that associated with delayed onset muscle soreness (DOMS) and lymphedema. There are three primary fluid compartments in the human body between which fluids and their contents are exchanged. These primary fluid compartments are the vascular compartment (which consists of blood within the arteries, veins and capillaries), the extracellular (interstitial) compartment (which consists of fluids and their contents between the cells) and the lymphatic compartment which store and transport fluids and their materials within the lymphatic system.

Embodiment of the present invention treat DOMS, which is experienced as pain and stiffness following an episode of an athletic performance, unaccustomed exercise or strenuous activity in both athletic and non-athletic subjects, through the stimulation of lymph nodes and connective lymph channels.

Methods in accordance with embodiments of the present invention treat DOMS by physically stimulating the lymphatic system to prime and transport lymphatic fluid at an increased rate. Regions of the body that are adjacent to or on route from the injured site are identified and stimulated by the substantially planar non-circular orbital motion.

Before describing the method of treatment in detail, the following will initially illustrate the function of an apparatus for generating orbital motions such as those illustrated in FIG. 1.

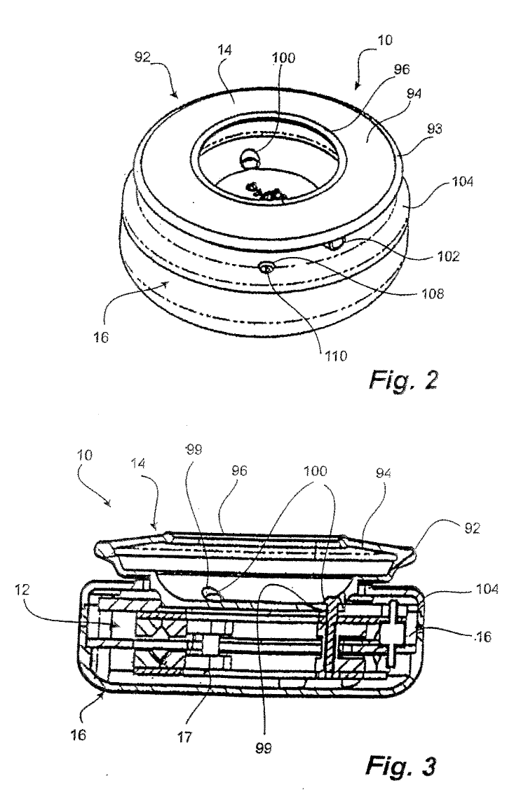

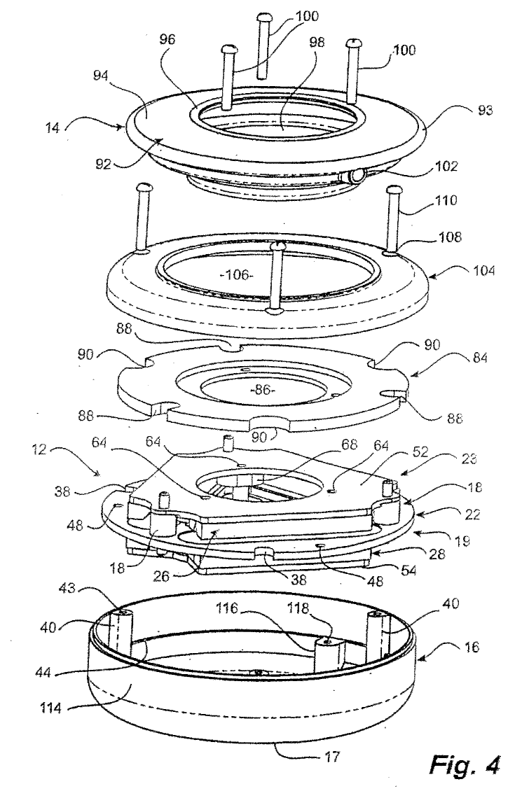

With reference to FIGS. 2 to 5, an apparatus for generating the orbital motions according to an embodiment of the present invention is now described. The apparatus is provided in the form of a hand held tool 10 and comprises an electric motor 12, a handle 14, a contact member 16, and a resilient coupling 18 coupled between the handle 14 and the contact member 16.

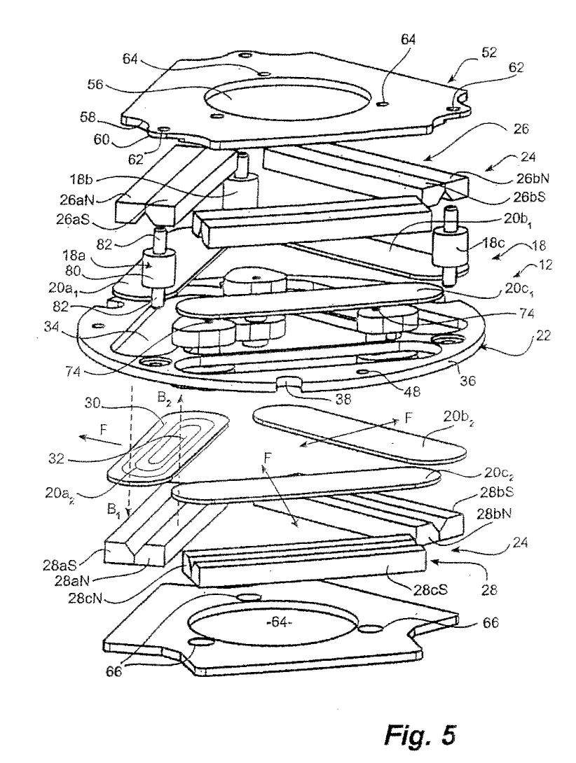

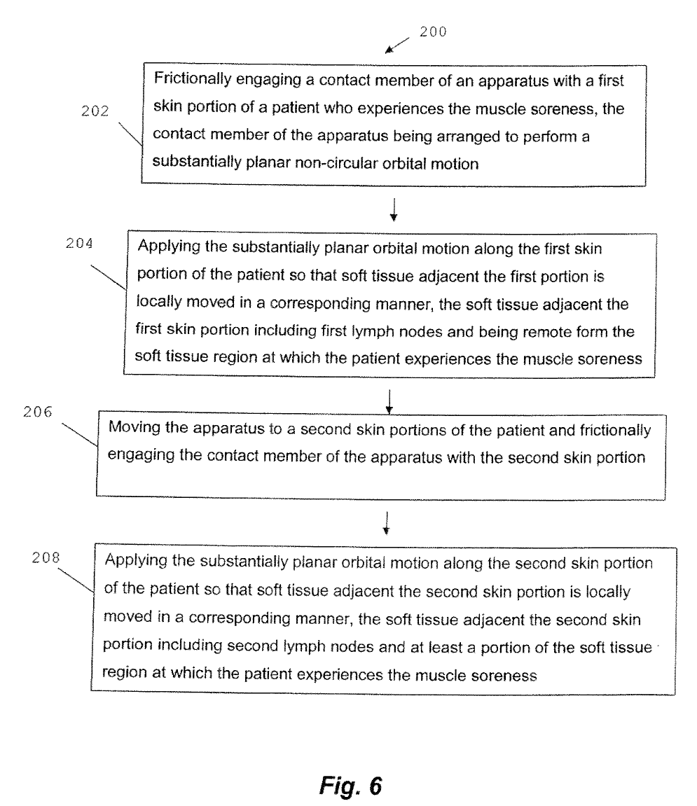

The contact member 16 has a contact surface portion 11 that lies in a first plane. With particular reference to FIGS. 4 and 5, the electric motor 12 comprises an armature 19, having a plurality of electric current carrying coils 20a, 20b and 20c (hereinafter referred to in general as “coils 20”) supported by a carrier 22, and a stator 23 which comprises a magnet 24 producing lines of magnetic flux traveling in a direction substantially perpendicular to a direction of current flowing through the coils 20 so as to produce a plurality of transverse linear (i.e. translational) forces F. Each coil is composed of two windings: coil 20a comprising windings 20a₁ and 20a₂, coil 20b comprising windings 20b₁, and 20b₂ and coil 20c comprising windings 20c₁, and 20c₂. As will be explained in greater detail below, the stator 23, and thus the magnet 24, is attached to the handle 14 while the armature 19, and thus the coils 20, are attached to the contact member 16. However, in an alternative embodiment, this configuration can be reversed so that the armature 19 is attached to the handle 14 and the stator 23 is attached to the contact member 16.

The resilient coupling 18 in this particular embodiment comprises three separate resilient members 18A, 18B and 18C. The resilient coupling 18 acts between the handle 14 and contact member 16 to enable relative planar motion therebetween. This is manifested by the coupling 18 applying a bias against the motion between the contact member 16 and the handle 14. The bias acts to return the contact member 16 and handle 14 to a mutually aligned position in response to the motion generated by the application of the translation forces F which act to move the contact member 16 relative to the handle 14.

As explained in greater detail below, the armature 19 is moveable with non-rotary translational motion in a second plane relative to the stator 23. The second plane is parallel to the first plane containing the contact surface portion 17. Thus, relative motion between the armature 19 and stator 23 produces corresponding motion of the contact member 16 relative to the handle 14.

A detailed explanation of the operation of the electric motor 12 is contained in U.S. Pat. No. 6,160,328, the contents of which are incorporated herein by way of reference. Nevertheless, a brief overview of the structure and function of the motor 12 is set out below.

The magnet 24 of the motor 12 is formed, in this embodiment, as sets of poles 26 and 28 on opposite sides of the coils 20. The set of poles 26 comprise three pairs of 26ₐₙ, 26ₐₛ; 26_{bn}, 26_{bs}; and 26_{cn} and 26_{cs}. The set of poles 28 comprises pairs of pole pieces 28ₐₛ, 28ₐₙ; 28_{bs}, 28_{bn}; 28_{cs} and 28_{cn}. The pole pieces in the sets 26 and 28 are axially aligned with each other, with axially aligned pole pieces being of opposite polarity. For example, pole piece 26ₐₙ, a magnetic north pole, is axially aligned with magnetic south pole piece 28ₐₛ, while the magnetic south pole piece 26ₐₛ is axially aligned with magnetic north pole piece 28ₐₙ. As a consequence, the magnetic field generated between these pole pieces contains lines of flux B1 extending in a downward direction and lines of magnetic flux B2 extending in an upward direction.

The windings 20a₁, and 20a₂ are disposed so that the lines of magnetic flux B1 and 22 extend through longitudinal segments of the windings 20a₁ and 20a₂. In FIG. 5 the winding 20a₂ is shown as having a current circulating in a clockwise direction. The interaction between the current flowing to the winding 20a₂ and the lines of magnetic flux B1 and B2 produce the translational force F. This force F acts on the armature 19/carrier 22 and, as explained in greater detail below, acts between the contact member 16 and handle 14. By a similar process, each group of pole pieces and coils produce corresponding forces F. These forces act in a plane containing the carrier 22.

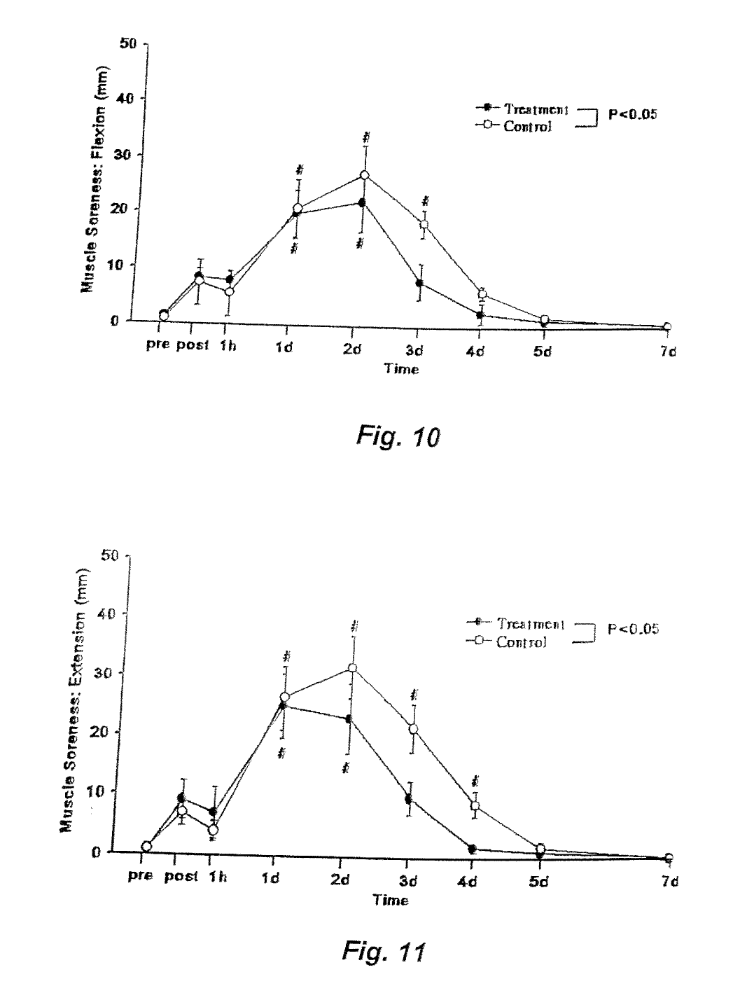

By supplying the motor 12 with a three-phase current where different phases are delivered to each of coils 20a, 20b and 20c, an orbital motion in a plane can be produced by the forces F. It is noted that this is an orbital motion, not a rotary motion. Further, by appropriate phasing and control of current magnitude, the planar motion generated by the forces F can follow any path that can be resolved into two orthogonal vectors in the plane. Thus, the motor 12 can generate planar motion following, for example, a FIG. 8, clover leaf or star-shaped path.

Each winding has an outer end 30 and an inner end 32. The windings of each coil are turned in opposite directions with the inner ends 32 connected together. The outer ends 30 of each winding provide connection points for current flowing into and out of a particular coil. By this arrangement, current circulates in the same direction (i.e. clockwise or anti-clockwise) in each of the windings of any particular coil.

The carrier 22 comprises a plate that is formed separately of the contact member 16 and attached or otherwise coupled to the contact member 16. The carrier 22 comprises a plurality of apertures 34, one for each of the coils 20; that is, both of the windings of each coil are seated within respective apertures 34. The coils 20 are made of a thickness substantially equal to the thickness of the carrier plate 22 so that the coils lie substantially flush with the carrier 22.

An outer peripheral edge 36 of the carrier 22 is formed with three equally spaced-apart U-shaped cutouts 38. The cutouts 38 receive respective upright posts 40 formed integrally about an inner circumferential surface 42 of the contact member 16. This keys the carrier 22 to the contact member 16. A threaded hole 43 is formed in each post 40. A circumferential ledge 44 is also formed about the inner circumferential surface 42 for seating the carrier 22.

The carrier 22 further comprises three evenly spaced counter-sunk holes 46 formed between adjacent apertures 34. A further set of three through holes 48 is formed in the carrier 22, the holes 48 being evenly spaced from each other, but offset from the counter sunk holes 46.

Finally, a central aperture 50 is formed in the carrier 22 inboard of the apertures 34.

The pole set 26 is magnetically coupled to first magnet plate 52, while the pole set 28 is magnetically coupled to a second magnet plate 54, as shown in FIG. 4.

The magnet plate 52 is in a general shape of a triangle, having a central circular aperture 56 and with each apex of the triangle removed. In place of the removed apex is a wave-shaped edge 58 having a central crest 60 formed with a hole 62 countersunk on an underside of the plate 52. A further set of three spaced-apart holes 64 is formed through the magnet plate 52 in board of and in radial alignment with the countersunk holes 60. The plate 52 forms one leg of a return path for magnetic flux generated by the magnet 24.

The magnet plate 54 forms a second leg of the return path for magnetic flux created by the magnet 24, and is also in the general shape of a triangle, but with each apex removed and with a central aperture 64 that is of the same diameter as, and in axial alignment with, the aperture 56. The plate 54 also includes a set of three equally spaced holes 66.

The combination of the magnet plates 52 and 54 and the pole sets 26 and 28 form the stator 23.

A plurality of spacers 68 space the pole sets 26 and 28 a minimum distance from opposite sides of the coils 20.

The handle 14 is in the general form of a saucer 92 with a annular lip 94 extending radially inward from an upper 93 edge of the saucer 92. The lip 94 has an inner circumferential edge 96 defining an opening 98. Three equally spaced-apart holes 99 are formed in the saucer portion 92 and are accessible through the opening 98. Respective screws 100 are received in the holes 99. A channel 102 extends through the saucer portion 92 to form a conduit for receiving a cable providing power and signaling to the motor 12.

An annular cap 104 is disposed between the handle 14 and the contact member 16. The cap 104 has a central aperture 106 that has a greater diameter than an outer diameter, the lower part of the saucer portion 92 extending through the aperture 106. The cap 104 is also provided with three equally spaced-apart holes 108 for receiving respective screws 110.

As seen in FIG. 4, the contact member 16 comprises an upright circumferential wall 114 extending about the planar contact surface portion 17. This in effect forms a receptacle for receiving the motor 12. In additional to the posts 40, the contact member 14 also comprises a plurality of upright posts 116 that extend only up to the ledge 44. Each of the posts 116 is provided with a central axially extending hole 118.

The combination of the contact member 16, cap 104 and handle 14 form a housing or casing for the tool 10.

By virtue of the resilient coupling 18, the armature 19 can move in a plane relative to the stator 23, and consequently the handle 14 can move in a parallel plane relative to the contact member 16.

When the tool 10 is used for massage, a therapist such as a physiotherapist holds the handle 14 with their fingers disposed about the upper edge 93 of the handle 14. When power is supplied to the motor 12, the forces F cause planar motion of the carrier 22, and thus the contact member 16 relative to the handle 14. As described above, a path of this planar motion can be controlled by appropriate phasing of the currents supplied to the coils 20. By manipulating buttons or controls on a hand-held controller (not shown), characteristics of the current supplied to the coils 20 can be varied to enable variation in the frequency, amplitude and pattern of motion of the contact member 16 relative to the handle 14. When the contact surface 17 of the contact member 16 is applied to the skin or body part of a person, the motion of the contact member 16 is transferred by friction or contact to the patient.

Further details of the hand held tool are described in PCT international application PCT/AU2006/001856, which is incorporated herein by cross-reference.

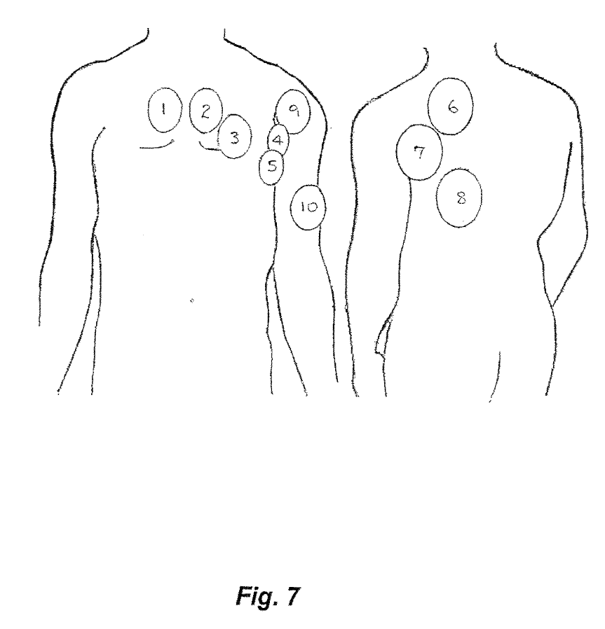

Referring now to FIGS. 6-13, a method of treating muscle soreness according to a specific embodiment of the present invention is now described in further detail. In this embodiment the method uses the hand held tool as described above with reference to FIGS. 2-5 and is conducted to treat DOMS.

FIG. 6 illustrates method 200 which comprises the initial step 202 of frictionally engaging a contact member of an apparatus with a first skin portion of a patient who experiences the muscle soreness. In this embodiment the contact member of the apparatus is arranged to perform a substantially planar non-circular motion. The soft tissue adjacent the first skin portion including first lymph nodes and being remote from the soft tissue region in which the patient experiences the muscle soreness.

The method 200 also comprises step 204 of applying the substantially non-circular orbital motion to the first skin portion of the patient so that soft tissue adjacent the first portion is locally moved in a corresponding manner. The soft tissue adjacent the first skin portion includes first lymph nodes and is remote from the soft: tissue region in which the patient experiences the muscle soreness.

Further, the method 200 comprises step 206 in which the apparatus is moved to a second skin portion and the contact member is frictionally engaged with the second skin portion. The soft tissue adjacent the second skin portion includes second lymph nodes and at least a portion of the soft tissue region in which the patient experiences the muscle soreness.

The method 200 also comprises step 208 of applying the substantially planar non-circular orbital motion along the second skin portion of the patient so that soft tissue adjacent the second skin portion is locally moved in a corresponding manner.

The apparatus may function with a fixed pattern rate or may operate with a dynamically changing range of fundamental frequencies to increase the number of sweeping harmonics applied to the skin portions of a patient.

The contact member of the apparatus may function with a fixed displacement (amplitude) whilst the contact member moves at a fixed fundamental frequency or the displacement may be dynamically adjusted to a greater amplitude if the frequency is reduced or a lesser amplitude if the frequency is increased.

The apparatus may also function with a dynamically changing range of displacements (amplitude) whilst the contact member moves at a determined fundamental frequency at a skin portion of a patient.

The method 200 typically comprises applying the substantially planar orbital motion to a plurality of first and second skin portions. In this embodiment the method 200 comprises applying the substantially planar orbital motion at a plurality of positions along a path from a proximal location that is remote from the soft tissue region in which the patient experiences the muscle soreness to the soft tissue region in which the patient experiences the muscle soreness.

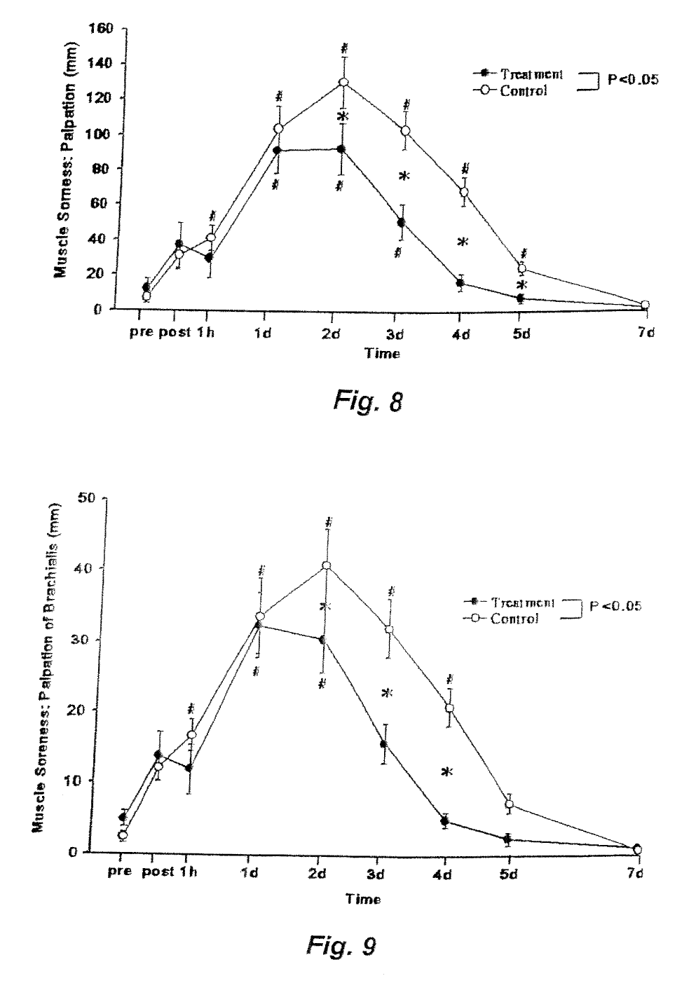

FIG. 7 illustrates positions of skin portions to which the substantially planar non-circular orbital motion is applied. In this example the apparatus along with the contact member is successfully moved to a total of 22 positions (starting with position 1 as indicated in FIG. 7, which illustrates 10 exemplary positions of the 22 positions). The patients experienced muscle soreness at the upper left arm and elbow flexor. Initially the substantially planar non-circular orbital motion was applied to skin portions at the torso proximal to the arm and in the proximity of underlying lymph nodes before applying that motion to selected positions at the upper left arm. In this embodiment the substantially planar non-circular orbital motion was applied with a frequency of approximately 65 Hz and an amplitude of approximately 0.76 mm. A person skilled in the art will appreciate that alternatively other frequencies and amplitudes may be used. Further, a person skilled in the art will appreciate that the positions at the skin portions as illustrated in FIG. 7 are only examples of numerous possible positions.

In this embodiment the substantially planar non-circular orbital motion is a complex motion that has a range of associated harmonics. The complex motion with its fundamental frequency and associated harmonics “ripple” along the soft tissue from each skin portion to which the motion is applied and activates lymph nodes by distorting their membranes from various directions, which facilitates pumping of lymphatic fluid through the lymph system.

FIGS. 8-13 illustrate results of experiments conducted with a number of subjects. The subjects were male and aged 18-29 years. None of the subjects had performed resistance training of the upper limbs for at least 6 months prior to the study, had current or previous injuries of the elbow joints, elbow flexors, tendons or other tissue around the elbow and shoulder joints and had no neural muscular disorder.

Each exercise included 10 sets of 6 maximum voluntary eccentric contractions of the elbow flexors against a lever arm of an isokinetic dynamometer, moving at a constant velocity of 30° s⁻¹. Each subject was positioned on an arm preacher curl bench. One elbow of each subject was aligned with the axis of rotation of the dynamometer. The elbow joint was forcibly moved from a flexed position (approximately 90°) to a fully extended position (approximately 180°) within approximately 3 seconds.

The subjects were verbally encouraged to generate a maximal isometric force at the starting position and to maximally resist against the elbow extension action throughout the full range of motion. After each eccentric action, the isokinetic dynamometer returned the arm to the flexed position at a velocity of approximately 9° s⁻¹ while the subjects were asked to relax the arm, giving a 10 second passive recovery between contractions. The rest period between the sets was 3 minutes.

One arm of each subject received treatments using the above-described method 200. The study validation was controlled through the use of a cross over method whereby each subject's soreness was matched against themselves as they repeated the DOMS inducing exercise on the opposite arm (control); some 3 to 4 weeks apart (randomly selected before or after each other) and this time they received no treatment as described in method 200. For each treatment the hand held tool was moved to positions as illustrated in FIG. 7 and the planar non-circular orbital motion was applied at each position for 1-2 minutes. The treatment was also applied 30 minutes, 1 day, 2 days, 3 days and 4 days after the exercise.

The level of muscle soreness was assessed using a 100 mm visual analogue scale (VAS). On that scale 0 mm indicated no pain and 100 mm indicated extreme pain. The subjects were asked to mark their level of experienced muscle soreness on the VAS while the corresponding joint was flexed and extended. Palpation was also applied using the index and middle fingers at five selected positions along the arm. The sum of the values detected at the five positions was used for further analysis.

FIGS. 8 to 13 show levels of muscle soreness as experienced by subjects (with respect to the VAS) as a function of time relative to the time of each exercise. FIG. 8 illustrates muscle soreness associated with palpation applied to the upper arm, FIG. 9 illustrates muscle soreness associated with palpation of the brachialis, FIG. 10 illustrates muscle soreness associated with flexion of an elbow and FIG. 11 illustrates muscle soreness associated with extension of an arm. Each of the FIGS. 8 to 12 show data for the arm treated by the method 200 (“Treatment”) and data for a control arm (“Control”). In each case the level of muscular soreness as experienced by the subject has decreased significantly approximately one day after the exercise if the subject was treated by the method 200.

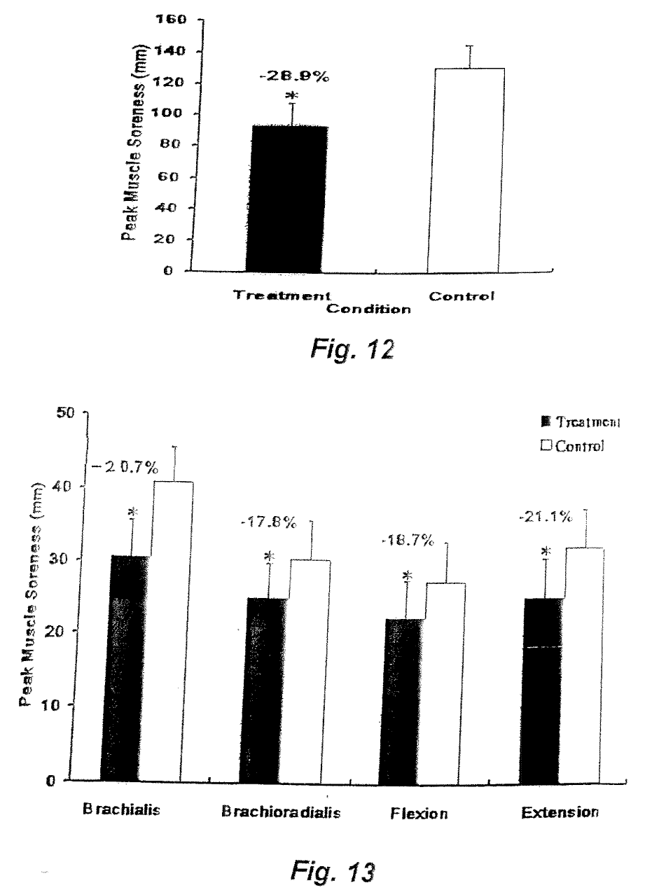

FIG. 12 shows peak muscle soreness upon palpation applied to the upper arm. The average peak muscle soreness of the treated arms was approximately 29% reduced compared to the average peak muscle soreness experienced without the treatment.

FIG. 13 shows peak muscle soreness upon palpation of the brachialis, palpation of the brachioradialis, flexion and extension of the arms. Again, the average peak muscle soreness of the treated arms was significantly reduced compared to the average peak muscle soreness experienced without the treatment. Further, the inventor has observed that the above-defined method also increases the range of motion (ROM).

In another embodiment the present invention provides a method of treating a soft tissue oedema and typically relates to treating lymphedema. A person skilled in the art will appreciate that variations of the method 200 as described above may also be used to treat lymphedema and related diseases as the throughput of lymphatic fluid through the lymph vessels is facilitated by the application of the substantially planar non-circular orbital motion at selected positions.

Although the invention has been described with reference to particular examples, it will be appreciated by those skilled in the art that the invention may be embodied in many other forms. For example, the method may also be applied for treatment of muscular soreness other than DOMS.

What is claimed is:

1. A method of treating muscle soreness, the method comprising the steps of:
frictionally engaging a contact member of an apparatus with skin portions of the patient who experiences the muscle soreness, the contact member of the apparatus being arranged to perform a substantially planar orbital motion along the surface of the skin portions; and
applying the substantially planar orbital motion along the skin portions of the patient so that soft tissue adjacent the skin portions is locally moved in a corresponding manner, the skin portions including first and second skin portions, the soft tissue adjacent the first skin portion including first lymph nodes and being remote from the soft tissue region in which the patient experiences the muscle soreness, the soft tissue adjacent the second skin portion including second lymph nodes and at least a portion of the soft tissue region in which the patient experiences the muscle soreness;
whereby the movement of the soft tissue results in a distortion of portions of the first and second lymph nodes whereby throughput of lymphatic fluid through the first and second lymph nodes is enhanced.

2. The method of claim 1 wherein the method is conducted so that the contact member is initially engaged with the first skin portion and subsequently with the second skin portion, and the substantially planar orbital motion is initially applied to the first skin portion and subsequently to the second skin portion.

3. The method of claim 1 wherein the substantially planar orbital motion is a non-circular motion having a fundamental frequency and one or more associated harmonics.

4. A method of treating muscle soreness, the method comprising the steps of:
frictionally engaging a contact member of an apparatus with a skin portion of a patient who experiences the muscle soreness, the contact member of the apparatus being arranged to perform a substantially planar non-circular orbital motion along the surface of the skin portion, the motion having a fundamental frequency and one or more associated harmonics; and
applying the substantially planar non-circular orbital motion along the skin portion of the patient so that soft tissue adjacent the skin portion is locally moved in a corresponding manner and at least portions of the lymph system positioned in the soft tissue are distorted by that motion;
whereby throughput of lymphatic fluid through that portion of the lymph system is enhanced.

5. The method of claim 4 comprising applying the substantially planar non-circular orbital motion along first and second skin portions of the patient so that soft tissue adjacent the first and second skin portions is locally moved in a corresponding manner, the soft tissue adjacent the first skin portion including first lymph nodes and being remote from the region in which the patient experiences the muscle soreness, the soft tissue adjacent the second skin portion including second lymph nodes and at least a portion of the region in which the patient experiences the muscle soreness.

6. The method of claim 5 comprising applying the substantially planar orbital motion initially to the first skin portion and subsequently to the second skin portion.

7. The method of claim 1 wherein the method is conducted to treat delayed onset muscle soreness (DOMS).

8. The method of claim 1 comprising applying the substantially planar orbital motion to a plurality of first and second skin portions.

9. The method of claim 8 wherein the method is conducted so that the substantially planar orbital motion is initially applied to all first skin portions and subsequently to all second skin portions.

10. The method of claim 8 comprising moving the apparatus with the contact member so that substantially planar orbital motion is applied at a plurality of positions along a path from an initial proximal location that is remote from the soft tissue region in which the patient experiences the muscle soreness to a position at the soft tissue region in which the patient experiences the muscle soreness.

11. The method of claim 1 wherein the method is conducted to provide also analgesic pain relief.

12. The method of claim 1 wherein the method is conducted to increase a range of motion (ROM).

13. A method of treating a soft tissue oedema, the method comprising the steps of:
frictionally engaging a contact member of an apparatus with a skin portion of a patient who experiences the soft tissue oedema, the contact member of the apparatus being arranged to perform a substantially planar non-circular orbital motion along the surface of the skin portion, the motion having a fundamental frequency and one or more associated harmonics; and
applying the substantially planar non-circular orbital motion to at least one skin portion of the patient so that soft tissue adjacent the skin portion is locally moved in a corresponding manner whereby the substantially planar non-circular orbital motion causes distortions of at least a portion of the lymph system whereby throughput of lymphatic fluid through the portion of the lymph system is increased.

14. The method of claim 13 wherein the soft tissue oedema relates to lymphedema.

15. The method of claim 13 comprising moving the apparatus to further skin portions of the patient and at each further skin position frictionally engaging the contact member of the apparatus with the respective further skin portion; and
applying the substantially planar non-circular orbital motion to each further skin portion of the patient so that soft tissue adjacent each further skin portion is locally moved in a corresponding manner.

16. The method of claim 1, comprising applying the substantially planar orbital motion or substantially non-circular orbital motion to more than 5 portions of the patient.

17. The method of claim 1 comprising applying the substantially planar orbital motion or substantially non-circular orbital motion to more than 10 portions of the patient.

18. The method of claim 1 comprising selecting an increase or decrease in amplitude displacement of the contact member.

19. The method of claim 1, comprising selecting an extension of the movement of the soft tissue along the surface of the patient by selecting the frequency of the planar non-circular orbital motion that is applied by the contact member.

20. The method of claim 1 wherein the substantially planar non-circular orbital motion is associated with a hypotrochoidal or epitrochoidal pathway of motion of the contact member.

21. The method of claim 1 comprising applying a harmonic frequency motion component to the skin portions.

22. An apparatus for treating muscle soreness, the apparatus being arranged for operation in accordance with the method of claim 1.

23. An apparatus for reducing lymphedema, the apparatus being arranged for operation in accordance with the method of claim 13.

24. A hand held tool comprising:
a handle;
a contact member having a contact surface portion lying in a first plane;
an electric motor having a stator and an armature, the armature being moveable with a non-rotary translational motion of the armature in a second plane relative to the stator, wherein the handle is attached to one of the stator and the armature and the contact member is attached to another of the stator, and wherein the armature with the handle and the contact surface are maintained at substantially constant spacing from each other while the armature is in motion, and wherein the first plane is parallel to the second plane, whereby the relative motion between the armature and the stator produces a corresponding motion of the contact member relative to the handle.
